(19) United States
(12) Patent Application Publication
(10) Pub. No.: US 2012/0317082 A1
(43) Pub. Date: Dec. 13, 2012

(54) QUERY-BASED INFORMATION HOLD

(75) Inventors: Sarosh Anwar, Redmond, WA (US); Yingtao Dong, Redmond, WA (US); Sean Ferguson, Renton, WA (US); Anupama Janardhan, Seattle, WA (US); Khoj Ladha, Sammamish, WA (US); Ashish Malgi, Redmond, WA (US); Thottam Sriram, Redmond, WA (US); Namra Tayyab, Bothell, WA (US)

(73) Assignee: MICROSOFT CORPORATION, Redmond, WA (US)

(21) Appl. No.: 13/158,515

(22) Filed: Jun. 13, 2011

(51) Int. Cl. G06F 17/30; G06F 7/00

(52) U.S. Cl. 707/692; 707/687; 707/694; 707/E17.001

(57) ABSTRACT

Systems and methods for implementing a query-based hold on electronic items hosted by a communication device and/or system. Electronic items from a plurality of user-specific folders are purged and copied to a discovery hold folder. The purged items, along with all existing items, contained within the discovery hold folder are evaluated against the query-based hold criteria. Items that fail to meet the query-based hold criteria are permanently deleted from the discovery hold folder. Items that meet the query-based hold criteria are maintained within discovery hold folder.

### BACKGROUND

E-discovery is generally the process of identifying electronic information that might be relevant in a legal matter. This information frequently includes e-mail messages and other types of electronic documents. In many instances, quality and compliance issues may arise due to the sheer volume of held information, some of which may not be relevant to anticipated litigation. Extraneous and/or non-relevant information may hamper the E-discovery process and expose an organization to losses that may otherwise have been avoided. In other scenarios, it is possible that relevant information could be lost if proper safeguards are not put in place to preserve the relevant information.

### SUMMARY

The present disclosure is generally directed to systems and methods for selectively preserving electronic items hosted by a communication system and/or device in a networked computing environment.

In one aspect, a method for implementing a query-based hold on electronic items hosted by a communication device is disclosed. The method generally includes receiving, at the communication device, definition of a query-based hold criteria; purging items from a plurality of user-specific folders maintained by the communication device; copying the purged items to a hold folder maintained by the communication device; evaluating all items within the hold folder against the query-based hold criteria; and permanently deleting all items within the hold folder that fail to meet the query-based hold criteria.

In another aspect, a communication system is disclosed. The communication system generally includes a processing unit and a system memory connected to the processing unit. The system memory generally includes instructions that, when executed by the processing unit, cause the processing unit to instantiate a query-based hold module configured to: receive definition of a query-based hold criteria; purge items from a plurality of user-specific folders maintained by the communication system; copy the purged items to a hold folder maintained by the communication system; evaluate all items within the hold folder against the query-based hold criteria; permanently delete all items within the hold folder that fail to meet the query-based hold criteria; and maintain all items within the hold folder that meet the query-based hold criteria.

In yet another aspect, a computer readable storage medium having computer-executable instructions is disclosed. The computer-executable instructions when executed by a computing device, cause the computing device to generally perform steps including: receiving, at the computing device, definition of a configurable hold criteria of a query-based hold, the configurable hold criteria including specification of one or more search terms, specification of one or more Boolean expressions, and specification of a search date range; receiving an instruction enabling the query-based hold and an instruction defining a hold time duration for the query-based hold; receiving an instruction enabling deduplication of search results of the query-based hold; receiving an instruction enabling logging of search results of the query-based hold; periodically purging e-mail items from a plurality of user-specific folders maintained by the computing device; copying the purged e-mail items to a hold folder maintained by the computing device; evaluating all e-mail items within the hold folder against the query-based hold criteria; permanently deleting all e-mail items within the hold folder that fail to meet the query-based hold criteria; maintaining all e-mail items within the hold folder that meet the query-based hold criteria; and receiving an instruction requesting a preview of all e-mail items maintained within the hold folder.

This Summary is provided to introduce a selection of concepts, in a simplified form, that are further described below in the Detailed Description. This Summary is not intended to be used in any way to limit the scope of the claimed subject matter. Rather, the claimed subject matter is defined by the language set forth in the Claims of the present disclosure.

### DESCRIPTION OF THE DRAWINGS

Aspects of the present disclosure may be more completely understood in consideration of the following detailed description of various embodiments in connection with the accompanying drawings.

FIG. 1 shows an example networked computing environment.

FIG. 2 shows an example server computing device.

FIG. 3 shows example logical modules of a client computing device.

FIG. 4 shows a first example operating environment configured for selectively preserving electronic items hosted by a communication system in a networked computing environment.

FIG. 5 shows a flowchart of an example method for selectively preserving electronic items within a mailbox module.

FIG. 6 shows a flowchart of an example method for placing and modifying a query-based hold on a mailbox module.

FIG. 7 shows a first view of an example hold criteria interface.

FIG. 8 shows a second view of an example hold criteria interface.

FIG. 9 shows a third view of an example hold criteria interface.

FIG. 10 shows an example query validation interface.

FIG. 11 shows an example search result preview pane.

FIG. 12 shows a second example operating environment configured for selectively preserving electronic items hosted by a communication system in a networked computing environment.

### DETAILED DESCRIPTION

Embodiments of the present disclosure are directed to systems and methods for selectively preserving electronic items, such as, for example e-mail messages, hosted by a communication system in a networked computing environment.

In one embodiment, a business server is configured to evaluate content of e-mail messages prior to permanent deletion of the same from the communication system. The evaluation is based on a query that defines a configurable hold criteria for placing e-mail messages “on-hold.” The query can be configured to capture those emails that are perceived as potentially relevant to an E-discovery process.

Although not so limited, an appreciation of the various aspects of the present disclosure will be gained through a discussion of the examples provided below.

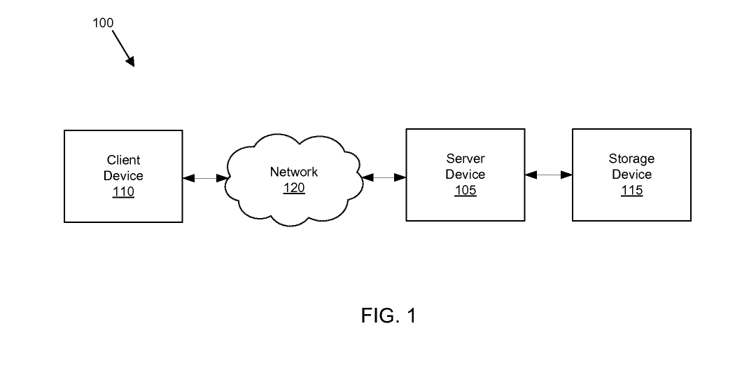

FIG. 1 shows an example networked computing environment 100 in accordance with the present disclosure. The environment 100 includes a server device 105, a client device 110, a storage device 115, and a network 120. Other embodiments are possible. For example, the environment 100 may generally include more or fewer devices, networks, and other components as desired.

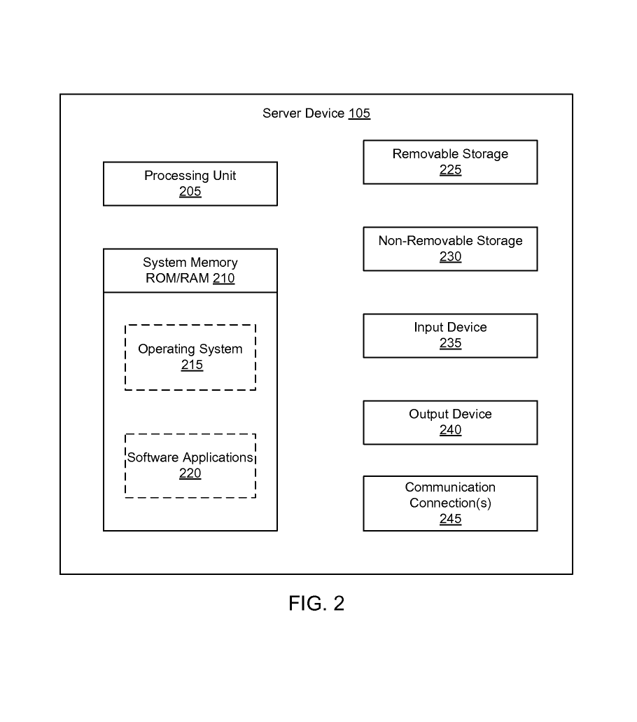

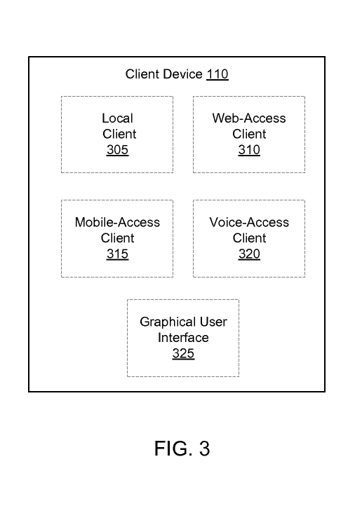

The server device 105 and the client device 110 are computing devices. Generally, the server device 105 is configured as a business server that implements business processes, and the client device 110 is a programmable machine configured to enable a user to access and/or implement functionality of the server device 105, as described further below in connection with FIGS. 2 and 3.

The storage device 115 is an electronic data storage device, such as a relational database or any other type of persistent data storage device. The storage device 115 stores data in a predefined format such that the server device 105 can query, modify, and/or manage electronic data stored thereon. Example electronic data includes information related to directory services, authentication services, administration services, and other services such as managed by the ACTIVE DIRECTORY® directory service from Microsoft Corporation. Other embodiments of the storage device 115 are possible. Other embodiments are possible.

The network 120 is a bi-directional data communication path for data transfer between one or more devices. In the example shown, the network 120 establishes a communication path for data transfer between the client device 110 and the server device 105. In general, the network 120 can be of any of a number of wireless or hardwired WAN, LAN, Internet, or other packet-based communication networks such that data can be transferred among the respective elements of the environment 100. Other embodiments of the network 120 are possible.

Referring now to FIG. 2, the server device 105 of FIG. 1 is shown in further detail. As mentioned above, the server device 105 is a computing device. An example computing device includes a desktop computer, laptop computer, server computer, personal data assistant, smartphone, netbook, notebook, video game console, etc.

The server device 105 includes a processing unit 205 and a system memory 210. The system memory 210 stores an operating system 215 for controlling the operation of the server device 105 and/or another computing device(s). An example operating system includes the WINDOWS® operating system from Microsoft Corporation of Redmond, Wash. Other embodiments are possible.

The system memory 210 further includes one or more software applications 220. Software applications 220 include many different types of single and multiple-functionality programs, such as a server program, an electronic mail program, a calendaring program, an Internet browsing program, a spreadsheet program, a program to track and report information, a word processing program, and many others.

One example program is the Office suite of business applications from Microsoft Corporation. Another example program includes the Exchange Server, also from Microsoft Corporation. The Exchange Server is an example of a business server that implements messaging and collaborative business processes in support of electronic mail, calendaring, and contacts and tasks features. Another example business server includes the SHAREPOINT® collaboration server, also from Microsoft Corporation, that implements business processes in support of collaboration, file sharing and web publishing. Still other types of programs are possible.

The system memory 210 is computer-readable media. Examples of computer-readable media include computer storage media and communication media. Computer storage media is physical and/or tangible media that is distinguished from communication media.

Computer storage media includes physical volatile and non-volatile, removable and non-removable media implemented in any method or technology for storage of information such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other physical medium which can be used to store the desired information and which can be accessed by the server device 105. Any such computer storage media may be part of or external to the server device 105. Such storage is illustrated in FIG. 2 by removable storage 225 and non-removable storage 230.

Communication media is typically embodied by computer-readable instructions, data structures, program modules, or other data, in a modulated data signal, such as a carrier wave or other transport mechanism, and includes any information delivery media. The term “modulated data signal” describes a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 105 also includes any number and type of an input device 235 and output device 240. An example input device 235 includes a keyboard, mouse, pen, voice input device, touch input device, and others. An example output device 240 includes a display, speakers, printer, and others. The server device 105 also includes a communication connection 245 configured to enable communications with other computing devices over a network (e.g., network 120 of FIG. 1) in a distributed computing system environment.

The client device 110 is configured in a manner similar to that of the server device 105 described above. Referring now additionally to FIG. 3, the client device 110 is also configured to include one or more different types of client interfaces to access functionality of the server device 105. In the example shown, the client device 110 includes a local client 305, a web-access client 310, a mobile-access client 315, a voice-access client 320, and a graphical user interface (GUI) 325. Other types of client interfaces to the server device 105 are possible as well.

The local client 305 is configured as a dedicated messaging and collaboration client that serves as an interface to the server device 105, and is part of a suite of applications executing on the client device 110. In one embodiment, the local client 305 includes the OUTLOOK® messaging and collaboration client, an e-mail application that is part of the Office suite from Microsoft Corporation. A user can compose, interact with, send and receive e-mails with the OUTLOOK® messaging and collaboration client. Other embodiments of the local client 305 are possible. For example, in one embodiment, the local client 305 includes the Office Communicator client from Microsoft Corporation, an instant messaging client used with Office Communications Server. Still other embodiments of the local client 305 are possible as well.

The web-access client 310 is configured to accesses the server device 105 remotely using a network connection, such as the Internet. In one embodiment, the web-access client 310 is the Outlook Web Access (OWA) webmail service of Exchange Server. In the example embodiment, the client device 110 uses a web browser to connect to Exchange Server via Outlook Web Access. This brings up a user interface similar to the interface in the OUTLOOK® messaging and collaboration client in which a user can compose, interact with, send and receive e-mails. Other embodiments of the web-access client 310 are possible. For example, the web-access client 310 may be configured to connect to SHAREPOINT® collaboration server to access corresponding collaboration, file sharing and web publishing services. Still other embodiments of the web-access client 310 are possible.

The mobile-access client 315 is another type of client interface to the server device 105. In one embodiment, the mobile-access client 315 includes the Mobile Access with ACTIVESYNC® synchronization technology or the Windows Mobile Device Center for WINDOWS VISTA® operating system or Windows 7 operating system, all from Microsoft Corporation. Example mobile devices include a cellular telephone, smartphone, a personal digital assistant, and many others. Other embodiments of the mobile-access client 315 are possible.

The voice-access client 320 is yet another type of client interface to the server device 105. In some embodiments, the voice-access client 320 includes Exchange Unified Messaging that is supported in Exchange Server. With Unified Messaging, users have one inbox for e-mail and voicemail. Voicemails are delivered directly into the OUTLOOK® messaging and collaboration client inbox. The message containing the voicemails may also include an attachment (e.g., an electronic document). Other embodiments of the voice-access client 320 are possible.

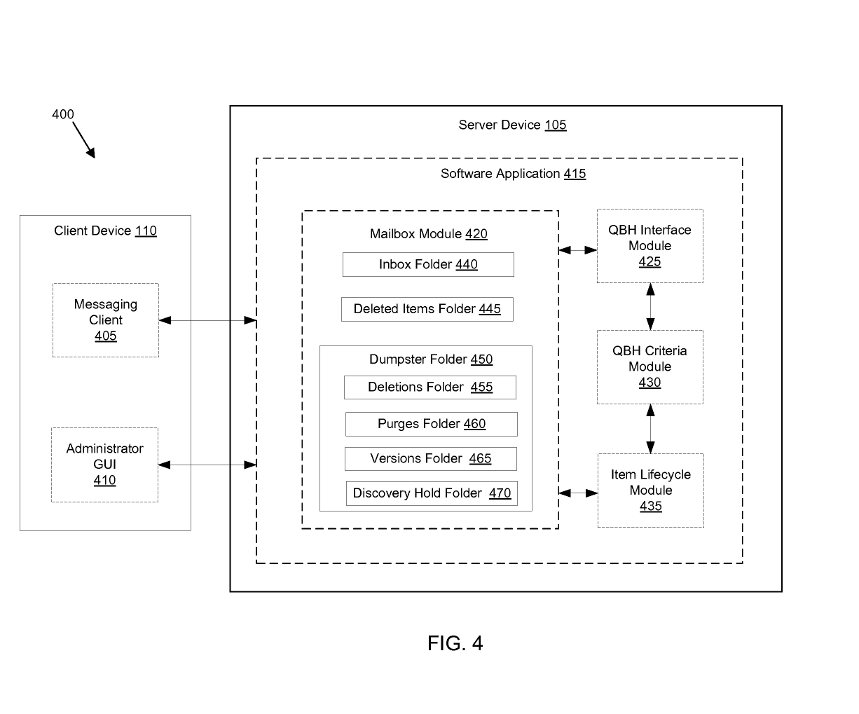

The GUI 325 includes logical modules of software executing on the client device 110 configured for enabling a user (e.g., an administrator) to interact with and invoke functionality of the server device 105. In one embodiment, the GUI 325 is a user interface that permits an administrator to configure, implement, and/or manage an E-discovery process in which electronic data associated with a software application (e.g., software applications 220) executing on the server device 105 is sought, located, secured, and/or searched with the intent of potentially using the electronic data as evidence in a legal matter. An example of such an interface is described in further detail below in connection with FIG. 4. Other embodiments of the GUI 325 are possible as well.

Referring now to FIG. 4, a schematic representation of an environment 400 illustrates a first example operating environment configured for selectively preserving electronic items hosted by a communication system in a networked computing environment. The example environment 400 includes the server device 105 and the client device 110 discussed above in connection with FIGS. 1-3. The client device 110 includes a messaging client 405 and an administrator GUI 410 each configured similar to like elements described above. The server device 105 includes a software application 415. The software application 415 includes a mailbox module 420, a query-based hold (QBH) interface module 425, a QBH criteria module 430, and an item lifecycle module 435.

Other embodiments of the environment 400 are possible. For example, the environment 400 may generally include more or fewer devices, and other elements or modules as desired. For example, in some embodiments, the QBH interface module 425, QBH criteria module 430, and item lifecycle module 435 are wholly incorporated into a single query-based hold module configured to implement a query-based hold on electronic items hosted by a communication system and/or computing device. Still other embodiments are possible.

The software application 415 includes logical modules of software executing on the server device 105 configured for implementing messaging and collaborative business processes in support of e-mail and other types of electronic items. In an Exchange implementation, other types of electronic items include appointment items, calendar items, task items, contact items, journal items, etc. The software application 415 additionally includes logical modules of software executing on the server device 105 configured for selectively preserving electronic items as part of an E-discovery process, described in further detail below.

The mailbox module 420 is a user-specific repository that stores electronic messaging items including, in the example embodiment, e-mail messages. In the example shown, the mailbox module 420 includes an inbox folder 440, a deleted items folder 445, and a dumpster folder 450.

The inbox folder 440 is configured to receive e-mail messages addressed to a particular user as identified by an e-email address (e.g., “john.doe@emailaddress.com”). The deleted items folder 445 is configured to store e-mail messages that are deleted from the inbox folder 440 (e.g., via “Delete” key selection). The deleted items folder 445 is also configured to store other “deleted” messaging electronic items (e.g., appointment items, calendar items, etc.) that are created and/or modified via functionality implemented by the software application 415. In general, electronic items stored within the inbox folder 440 and the deleted items folder 445 are exposed and accessible via the messaging client 405.

The dumpster folder 450 includes a deletions folder 455, a purges folder 460, a versions folder 465, and a discovery hold folder 470. The deletions folder 455 is configured as a discoverable repository for items that are manually removed from the deleted items folder 445 (e.g., via “Delete” key selection) or when an automated process “ages-out” items within the deleted items folder 445 on a scheduled basis (e.g., once per month). In example embodiments, items stored within the deletions folder 455 are exposed and accessible via the messaging client 405 for the purpose of recovery following unintentional or inadvertent deletion from the deleted items folder 445.

The purges folder 460 is configured as a repository for items that are removed from the deletions folder 455 (e.g., via “Delete” key selection). In general, such an action may be malicious in nature. For example, an unscrupulous user might wish to permanently dispose of or discard an incriminating e-mail message from the deletions folder 455, thinking that deletion of the same would permanently and irreparably remove the e-mail message from the mailbox module 420 and/or software application 415. However, when such an action is performed and the mailbox module 420 is under a “discovery hold” as part of an E-discovery process, the e-mail message of interest is placed in the purges folder 460 to prevent a “hard-deletion” of the e-mail message, discussed in further detail below.

In example embodiments, a “hard-deletion” corresponds to permanent, non-recoverable removal of items from the mailbox module 420 and/or software application 415. Items stored within the purges folder 460 are neither exposed nor accessible via the messaging client 405. Instead, items stored within the purges folder 460 are only accessible to authorized users via the administrator GUI 410.

The versions folder 465 is configured as an item repository that preserves original content of a given electronic item when the item is accessed and then subsequently modified from within either of the inbox folder 440 and the deleted items folder 445. For example, if a user attempts to alter content of an e-mail message stored within the deleted items folder 445 while the mailbox module 420 is under “discovery hold,” a copy-on-write is performed to preserve the original version of the e-mail message. This copy of the e-mail message is then placed in the versions folder 465. Items stored within the versions folder 465 are neither exposed nor accessible via the messaging client 405, and instead are only accessible to authorized users via the administrator GUI 410.

The discovery hold folder 470 is configured as a condition-based persistent repository for items that are removed from the deletions folder 455, purges folder 460, and versions folder 465 at least when an automated process simultaneously “ages-out” items within these respective folders on a scheduled basis (e.g., once per week, etc.) while the mailbox module 420 is under “discovery hold.” Items stored within the discovery hold folder 470 are neither exposed nor accessible via the messaging client 405, and instead are only accessible to authorized users via the administrator GUI 410.

The QBH interface module 425 is configured to enable an authorized individual (e.g., an administrator) to create, modify, and delete a “discovery hold” on the mailbox module 420 via the administrator GUI 410. In example embodiments, the “discovery hold” is associated with an E-discovery process in which content of items stored within the discovery hold folder 470 are evaluated prior to permanent deletion of the same from the mailbox module 420 and/or software application 415. The evaluation is based on a search query that defines a configurable hold criteria that enables granular, item-by-item control for placing only those items “on-hold” that are perceived as potentially relevant to the E-discovery process. The QBH interface module 425 is additionally configured to enable an authorized individual to view items within the discovery hold folder 470 that are placed on “discovery hold.”

The QBH criteria module 430 is configured to define and interpret hold criteria in accordance with one or more data structures and web methods associated with the hold criteria. As mentioned above, items stored within the discovery hold folder 470 are evaluated against the hold criteria to determine whether those respective items should persist within the discovery hold folder 470. Example data structures and web methods defined in accordance with the present disclosure include a “MailboxHoldStatus” data structure, a “MailboxHoldResult” data structure, a “SetHoldOnMailboxes” web method, and a “GetHoldOnMailboxes” web method.

In one embodiment, the “MailboxHoldStatus” data structure contains the following data:

| Parameter Name | Parameter Type | Parameter Description |
|---|---|---|
| Mailbox | String | Mailbox or DG object guid. |
| Status | HoldStatus enum | Hold status, e.g., NotOnHold, |
| | | Pending, OnHold, PartialHold, |
| | | or Failed. |
| AdditionalInfo | String | Additional info used for error |
| | | message if hold failed, or for |
| | | other informational/warning |
| | | message. |

In one embodiment, the “MailboxHoldResult” data structure contains the following data:

| Parameter Name | Parameter Type | Parameter Description |
|---|---|---|
| HoldId | String | Hold identifier passed by |
| | | caller, e.g., Sharepoint. |
| Query | String | Search query used for the |
| | | hold. |
| MailboxHoldStatuses | MailboxHoldStatus[ ] | List of mailbox and its |
| | | hold status. |

In one embodiment, the “SetHoldOnMailboxes” web method is used to create and release a query-based hold on search result items, and also to update a query associated with an existing query-based hold. An example request using the “SetHoldOnMailboxes” contains the following data:

| Parameter Name | Parameter Type | Parameter Description |
|---|---|---|
| ActionType | HoldAction | Type of hold action, e.g., |
| | enum | create, update, remove |
| | | (CRUDQ). In one example, |
| | | create and remove |
| | | corresponds to placing and |
| | | releasing a query-based |
| | | hold, update is used when |
| | | a caller changes the query. |
| HoldId | String | Hold identifier passed by |
| | | the caller. |
| Query | String | Search query, e.g., in AQS |
| | | format. |
| Mailboxes | String[ ] | A set of mailbox or DG |
| | | object guids. |
| Language | String | Query language. |
| IncludeNonIndexableItems | Bool | Inclusion of items that |
| | | could not be indexed |
| | | enabled/disabled. |
| Deduplication | Bool | De-duplication enabled/ |
| | | disabled. |
| WordStemming | Bool | Word stemming |
| | | enabled/disabled. |
| NearMisspellings | Bool | Near misspellings |
| | | enabled/disabled. |

An example response to the request using the “SetHoldOnMailboxes” web method includes the following data:

| Parameter Name | Parameter Type | Parameter Description |
|---|---|---|
| MailboxHoldResult | MailboxHoldResult | Mailbox hold result (contains |
| | | hold id, query and list of |
| | | mailbox and its hold status) |

In one embodiment, the “GetHoldOnMailboxes” web method is used to acquire status of a mailbox having a query-based hold being placed. An example request using the “GetHoldOnMailboxes” web method contains the following data:

| Parameter Name | Parameter Type | Parameter Description |
|---|---|---|
| HoldId | String | Hold identifier passed by caller, |
| | | e.g., Sharepoint. |

An example response to the request using the “GetHoldOnMailboxes” web method includes the following data:

| Parameter Name | Parameter Type | Parameter Description |
|---|---|---|
| MailboxHoldResult | MailboxHoldResult | Mailbox hold result, e.g., |
| | | contains hold id, query and |
| | | list of mailbox and hold |
| | | status. |

Still referring to FIG. 4, the item lifecycle module 435 is configured as a “garbage” collection process that periodically purges or “ages-out” items within the deletions folder 455, purges folder 460, and versions folder 465 according to a pre-defined policy (e.g., once per week). As part of the periodic purge, the item lifecycle module 435 transfers items contained within the respective folders 455-465 to the discovery hold folder 470 while the mailbox module 420 is under “discovery hold,” and then evaluates all items within the discovery hold folder 470 against the configurable hold criteria defined within the QBH criteria module 430. Those items within the discovery hold folder 470 that meet the hold criteria are maintained in the discovery hold folder 470. Those items within the discovery hold folder 470 that do not meet the hold criteria are “hard deleted” from the mailbox module 420 and/or software application 415.

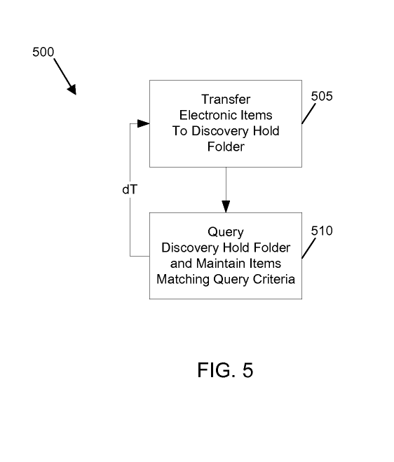

Example functionality associated with components of the software application 415 is described in further detail below in connection with FIGS. 5-12. For example, referring now to FIG. 5, an example method 500 for selectively preserving electronic items contained within the mailbox module 420 as part of an E-discovery process is shown according to the principles of the present disclosure.

The method 500 begins at an item transfer operation 505. The item transfer operation 505 corresponds to removal and deposition of all items contained within the deletions folder 455, purges folder 460, and versions folder 465 of the mailbox module 420 into the discovery hold folder 470. In example embodiments, the item transfer operation 505 is implemented by the item lifecycle module 435. Other embodiments are possible.

Operational flow then proceeds to a QBH operation 510. The QBH operation 510 corresponds to retrieval of hold criteria defined within the QBH criteria module 430 and evaluation of all items within the discovery hold folder 470 against the retrieved hold criteria as part of a search query. In other words, the discovery hold folder 470 is queried to identify those items contained therein that match the hold criteria. All items that do not meet the hold criteria are permanently and irretrievably deleted from the discovery hold folder 470. Those items within the discovery hold folder 470 that meet the hold criteria are maintained.

Operational flow then returns to the item transfer operation 505 following a predetermined time delay, dT. In example embodiments, the time delay, dT, is defined according to one of a default purge policy (e.g., two weeks) and a custom purge policy (e.g., one day, one week, etc.) In this manner, the example method 500 is implemented as a periodic process as long as a “discovery hold” is applied to the mailbox module 420.

The example method 500 is beneficial in many aspects. For example, inefficient systems typically hold all data of a mailbox in-place and/or copy all of the held data to a delocalized storage system. In contrast, the systems and method of the present disclosure enable a granular, item-by-item control mechanism for persisting only those items that are perceived as potentially relevant to an E-discovery process. This reduces the amount space required for storing on-hold data, and simultaneously alleviates any issues that may arise due to holding extraneous and/or non-relevant data.

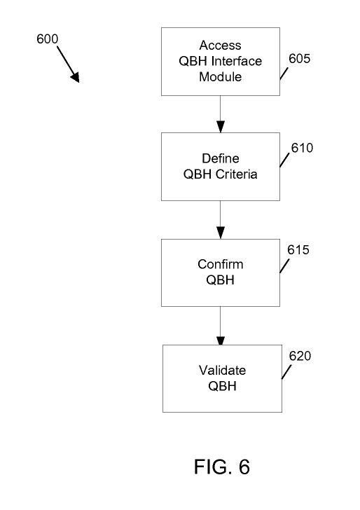

Referring now to FIG. 6, an example method 600 for placing and modifying a query-based hold on the mailbox module 420 of FIG. 4 as part of an E-discovery process is shown. In example embodiments, the administrator GUI 410 is used to interact with functionality of the QBH interface module 425 to define a configurable hold criteria that enables granular control for placing those items “on-hold” within the discovery hold folder 470 that may be potentially relevant to the E-discovery process.

At an operation 605, an individual, such as administrator or discovery manager, presents credentials (e.g., user name/password) via the administrator GUI 410 to access functionality of the QBH interface module 425. Next, at an operation 610, the individual accesses a search criteria window configured to permit definition of hold criteria for a query-based hold according to the principles of the present disclosure.

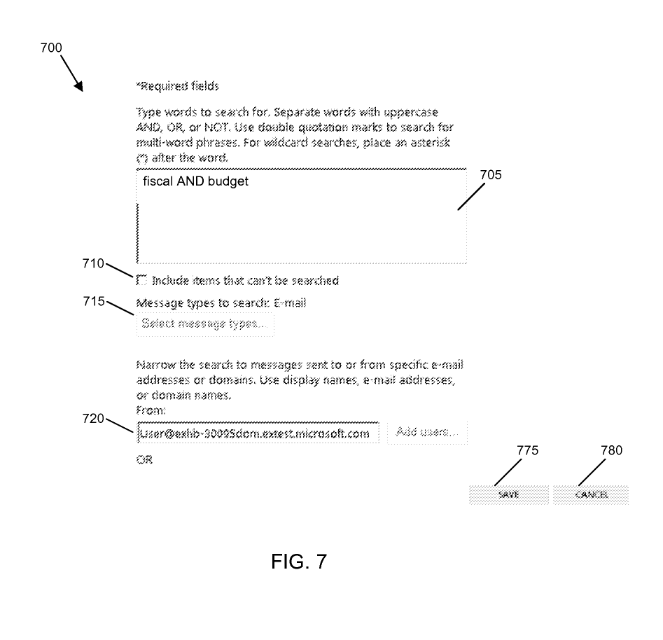

FIGS. 7-9 illustrate portions of an example hold criteria interface 700 in which to define hold criteria at operation 610.

For example, FIG. 7 shows the hold criteria interface 700 including a first element 705 configured to permit selective specification of QBH keyword(s) and/or Boolean expression(s) (e.g., “fiscal AND budget”), a second element 710 configured to permit selective specification of inclusion of items that cannot be searched (e.g., if particular information such as e-mail attachments cannot be searched because of password protection or other barriers, the default is to save these attachments if the second element 710 is selected), a third element 715 configured to permit selective specification of items to be searched (e.g., “E-mail”), and a fourth element 720 configured to permit selective specification of a QBH search narrowing parameter (e.g., “display names, e-mail address, or domain names”).

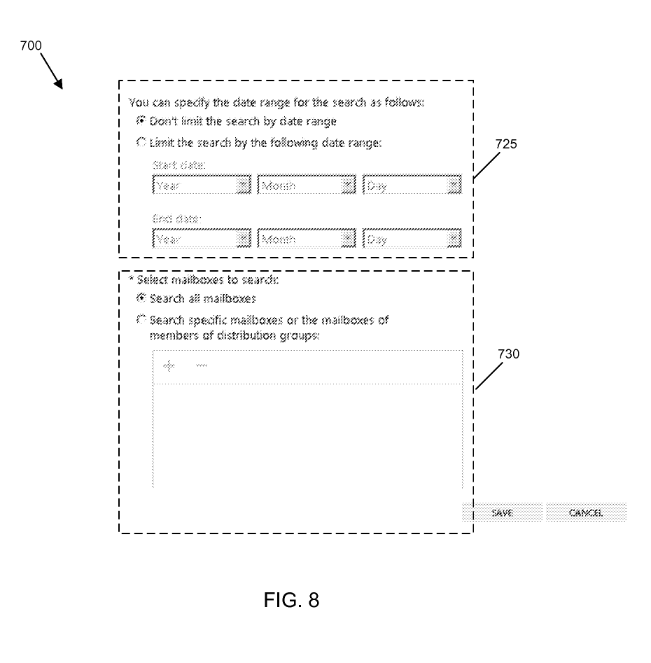

FIG. 8 shows the hold criteria interface 700 including a fifth element 725 configured to permit selective specification of a QBH search date range, and a sixth element 730 configured to permit selective specification of mailboxes of interest.

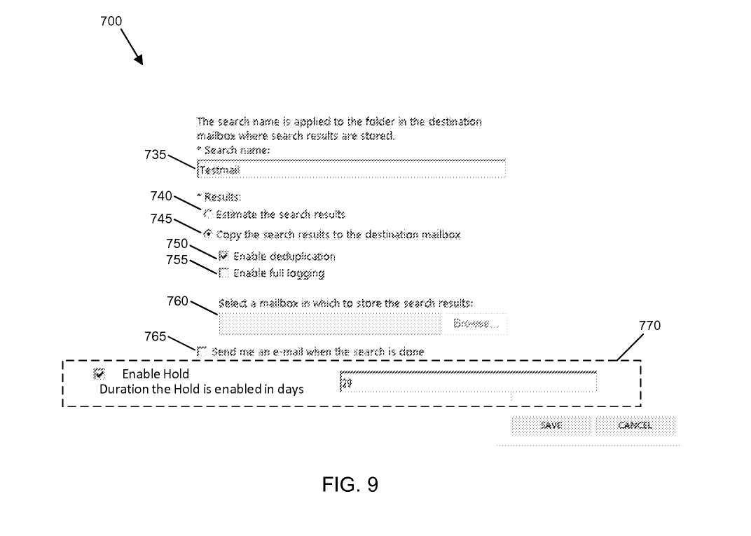

FIG. 9 shows the hold criteria interface 700 including a seventh element 735 configured to permit selective specification of a QBH search name (e.g., “Testmail”). An eighth element 740 is configured to permit selective specification of QBH search results estimation. A ninth element 745 is configured to permit selective specification for copying of QBH search results to a “destination mailbox,” described in further detail below. A tenth element 750 is configured to permit selective specification for “deduplication” of QBH search results. In example embodiments, “deduplication” involves a process whereby items are compared and duplicate items (either exact and/or near-exact duplicates) are purged so that space and processing power are maximized.

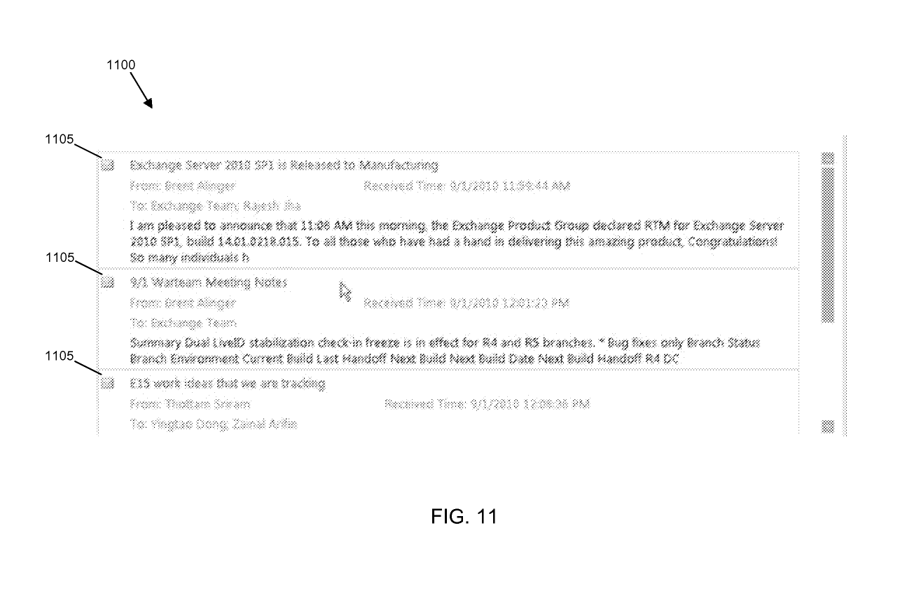

FIG. 9 further shows an eleventh element 755 is configured to permit selective specification of “full logging” of QBH search results. In example embodiments, “full logging” results in recordation of all activities performed by the system to a log file for auditing and/or debugging purposes. A twelfth element 760 configured to permit selective specification of QBH search results storage. In example embodiments, a “destination mailbox” as specified within the twelfth element 760 is a discoverable repository configured to hold one or more search results including items that are currently placed on QBH. An example interface configured to present the one or more search results to an individual is discussed in further detail below in connection with FIG. 11.

FIG. 9 additionally shows a thirteenth element 765 configured to permit selective specification of e-mail notification following search completion. In general, the e-mail notification is sent to an individual (e.g., “administrator@emailaddress.com”) who has previously defined a configurable hold criteria for a given E-discovery process. Other embodiments are possible. A fourteenth element 770 shown in FIG. 9 is configured to permit selective specification of hold enablement via checkbox and a hold duration specification (e.g., “29 days”) within a data entry window, described in further detail below. The hold criteria interface 700 additionally includes a QBH save button 775 and a QBH cancel button 780. Other embodiments of the hold criteria interface 700 are possible.

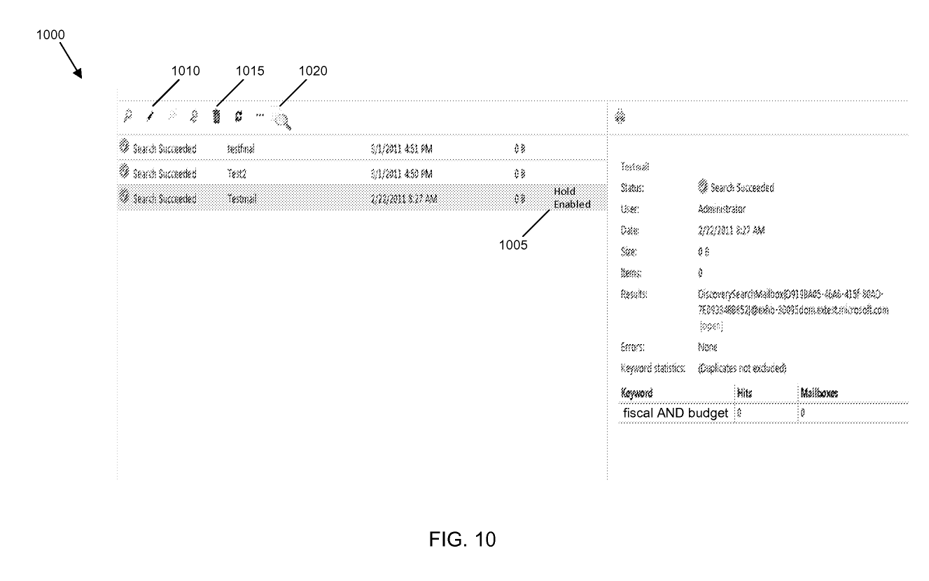

Following hold criteria definition, at operation 610 at FIG. 6, the individual accesses the search criteria interface (e.g., hold criteria interface 700) at an operation 615 to enable the hold and define a hold duration (e.g., via fourteenth element 770). Next, at an operation 620, the individual accesses a query validation interface that verifies that the QBH is enabled and/or placed. For example, FIG. 10 illustrates an example query validation interface 1000 in which a notification 1005 verifies QBH enablement (e.g., “Enabled”).

The query validation interface 1000 shown in FIG. 10 also includes an edit button 1010, a discard button 1015, and a preview button 1020.

The edit button 1010, when selected, permits modification and/or deletion of an existing QBH. For example, upon selection of the edit button 1010, the hold criteria interface 700 of FIGS. 7-9 is exposed to permit modification of the “Testmail” QBH (e.g., via changes to first element 705) or permit disablement of the “Testmail” QBH (e.g., via de-selection of hold enablement checkbox of the fourteenth element 770 and/or specification of hold duration as “0” days). Following disablement of the “Testmail” QBH, selection of the discard button 1015 permits deletion of the “Testmail” QBH from the system.

The preview button 1020, when selected, permits a preview of items currently placed QBH. For example, FIG. 11 illustrates an example preview pane 1100 in which one or more search results 1105 are displayed for viewing via the administrator GUI 410. In example embodiments, duplicates of search results 1105 are not displayed in the preview pane 1100 when “deduplication” is specified within the respective QBH (e.g., via selection of tenth element 750). Additionally, selection of the search results 1105 within the preview pane 1100 (e.g., via mouse selection) will display more information regarding the selected item.

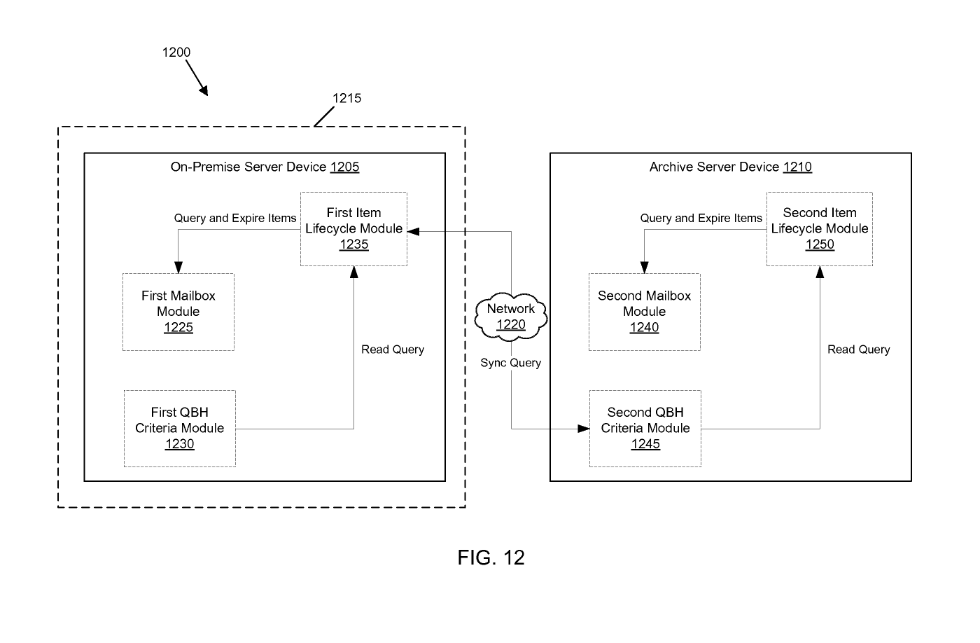

Referring now to FIG. 12, a second example operating environment 1200 is illustrated that is configured for selectively preserving electronic items hosted by a communication system in a networked computing environment. The example environment 1200 includes an on-premise server device 1205 and an archive server device 1210. In the example embodiment, the on-premise server device 1205 is an “internal” server device by virtue of being physically located within an enterprise 1215, and is accessible only to authorized individuals because of, for example, security measures such as firewalls. The archive server device 1210 is an “external” server device by virtue of being physically located outside the enterprise 1215 through, for example, a network 1220 such as the Internet.

The on-premise server device 1205 and the archive server device 1210 are configured similar to the server device 105 discussed above in connection with FIGS. 1-11. For example, the on-premise server device 1205 includes at least a first mailbox module 1225, a first QBH Criteria module 1230, and a first item lifecycle module 1235. The archive server device 1210 includes at least a second mailbox module 1240, a second QBH Criteria module 1245, and a second item lifecycle module 1250.

Other embodiments of the environment 1200 are possible. For example, the environment 1200 may generally include more or fewer devices, and other elements or modules as desired.

The environment 1200 is an example of “cross-premise” scenario in which the first mailbox module 1225 is a user primary mailbox, while the second mailbox module 1240 is an archive mailbox in a location different (e.g., data center) than the first mailbox module 1225. In general, the second item lifecycle module 1250 may not be necessarily be configured to connect with respective modules of the on-premise server device 1205 for the purpose of reading and/or applying hold criteria within the first QBH Criteria module 1230 to apply to items contained within the second mailbox module 1240. In the example embodiment, the first item lifecycle module 1235 writes the hold criteria within the first QBH Criteria module 1230 to the second QBH Criteria module 1245 to apply to items contained within the second mailbox module 1240 in accordance with the example QBH workflow discussed above in connection with FIGS. 1-11.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for implementing a query-based hold on electronic items hosted by a communication device, the method comprising:
receiving, at the communication device, definition of a query-based hold criteria comprising specification of one or more search terms;
purging items from a plurality of user-specific folders maintained by the communication device;
copying the purged items to a hold folder maintained by the communication device;
evaluating all items within the hold folder against the query-based hold criteria; and
permanently deleting all items within the hold folder that fail to meet the query-based hold criteria.

2. The method of claim 1, further comprising maintaining all items within the hold folder that meet the query-based hold criteria.

3. The method of claim 1, wherein the query-based hold criteria comprises:
specification of one or more search terms; specification of one or more Boolean expressions; and
specification of a search date range.

4. The method of claim 1, further comprising periodically purging items from the plurality of user-specific folders according to a predefined policy.

5. The method of claim 4, wherein the predefined policy is one of a custom purge policy and a default purge policy.

6. The method of claim 1, further comprising receiving an instruction enabling the query-based hold.

7. The method of claim 1, further comprising receiving an instruction defining a hold time duration for the query-based hold.

8. The method of claim 1, further comprising receiving an instruction enabling deduplication of search results of the query-based hold.

9. The method of claim 1, further comprising receiving an instruction enabling logging of search results of the query-based hold.

10. The method of claim 1, further comprising receiving an instruction requesting a preview of all items within the hold folder.

11. The method of claim 1, wherein the items are selected from a group consisting of: e-mail items; appointment items; calendar items; task items; contact items; and journal items.

12. A communication system, comprising:
a processing unit; and
a system memory connected to the processing unit, the system memory including instructions that, when executed by the processing unit, cause the processing unit to instantiate a query-based hold module configured to:
receive definition of a query-based hold criteria comprising specification of one or more search terms;
purge items from a plurality of user-specific folders maintained by the communication system;
copy the purged items to a hold folder maintained by the communication system;
evaluate all items within the hold folder against the query-based hold criteria;
permanently delete all items within the hold folder that fail to meet the query-based hold criteria; and
maintain all items within the hold folder that meet the query-based hold criteria.

13. The communication system of claim 12, wherein the query-based hold criteria comprises: specification of one or more search terms; specification of one or more Boolean expressions; and specification of a search date range.

14. The communication system of claim 12, wherein the query-based hold module is further configured to periodically purge items from the plurality of user-specific folders according to a predefined policy.

15. The communication system of claim 14, wherein the predefined policy is one of a custom purge policy and a default purge policy.

16. The communication system of claim 12, wherein the query-based hold module is further configured to receive a first instruction enabling the query-based hold and a second instruction defining a hold time duration for the query-based hold.

17. The communication system of claim 12, wherein the query-based hold module is further configured to receive a first instruction enabling deduplication of search results of the query-based hold, and a second instruction enabling logging of search results of the query-based hold.

18. The communication system of claim 12, wherein the query-based hold module is further configured to receive an instruction requesting a preview of all items within the hold folder.

19. The communication system of claim 12, wherein the items are selected from a group consisting of: e-mail items; appointment items; calendar items; task items; contact items; and journal items.

20. A computer readable storage medium having computer-executable instructions that, when executed by a computing device, cause the computing device to perform steps comprising:
receiving, at the computing device, definition of a configurable hold criteria of a query-based hold, the configurable hold criteria comprising specification of one or more search terms, specification of one or more Boolean expressions, and specification of a search date range;
receiving an instruction enabling the query-based hold and an instruction defining a hold time duration for the query-based hold;
receiving an instruction enabling deduplication of search results of the query-based hold;
receiving an instruction enabling logging of search results of the query-based hold;
periodically purging e-mail items from a plurality of user-specific folders maintained by the computing device;
copying the purged e-mail items to a hold folder maintained by the computing device;
evaluating all e-mail items within the hold folder against the hold criteria;
permanently deleting all e-mail items within the hold folder that fail to meet the query-based hold;
maintaining all e-mail items within the hold folder that meet the hold criteria; and
receiving an instruction requesting a preview of all e-mail items maintained within the hold folder.
